(19) United States
(12) Patent Application Publication
(10) Pub. No.: US 2025/0135563 A1
(43) Pub. Date: May 1, 2025

(54) ELECTRICAL TOOL AND METHOD

(71) Applicant: Festool GmbH, Wendlingen (DE)

(72) Inventors: Timo KUHLS, Stuttgart (DE); Jörg LARCHÉ, Remshalden (DE); Steffen MOHRING, Wendlingen (DE); Andi KERN, Hamburg (DE); Konradin WINDHORST, Hamburg (DE)

(21) Appl. No.: 18/835,294

(22) PCT Filed: Feb. 2, 2023
(86) PCT No.: PCT/EP2023/052566

§ 371 Date: Aug. 1, 2024

(30) Foreign Application Priority Data
Feb. 3, 2022 (DE) 10 2022 201 169.4

(51) Int. Cl. B23D 59/00

(52) U.S. Cl. CPC B23D 59/002

(57) ABSTRACT

An electric tool, in particular a sawing device, including a tool, in particular a saw blade, for machining a workpiece. The electric tool has an operator-control device via which there can be input a parameter value of at least one parameter relating to an operation of the tool, for example a cutting depth and/or a cutting angle. The operator-control device has a setting element, which is configured as a turn/push switch, for inputting the parameter value, and a display unit for displaying the at least one parameter value.

The invention relates to an electrical tool, in particular to a saw device, comprising a tool, in particular a saw blade, for machining a workpiece, wherein the electrical tool comprises an operating device, via which a parameter value of at least one parameter related to an operation of the tool, for example a cutting depth and/or cutting angle, can be inputted.

EP3484662A1 describes a torque wrench which is configured to connect to a remote display device.

DE102005031025B4 describes a mitre saw with a digital display for a mitre angle and an inclination angle.

EP755744B1 describes an input means with rows of buttons which are arranged on a panel of an operating unit.

An object of the invention lies in improving the operating ability of the electrical tool. The object is achieved by an electrical tool according to claim 1. The operating device of the electrical tool comprises an adjustment element which is designed as a rotary push button, for the input of a parameter value, as well as a display unit for the display of the parameter value.

The parameter value can be inputted in a very simple manner with the adjustment element. The user can examine as to whether the parameter value has been correctly inputted on the basis of the parameter value which is displayed on the display unit.

Advantageous further developments are the subject-matter of the dependent claims.

The invention further relates to a method for the operation of the electrical tool, comprising the step: input of the parameter value via the adjustment element.

Further exemplary details as well as exemplary embodiments are explained hereinafter with reference to the figures. Herein are shown in:

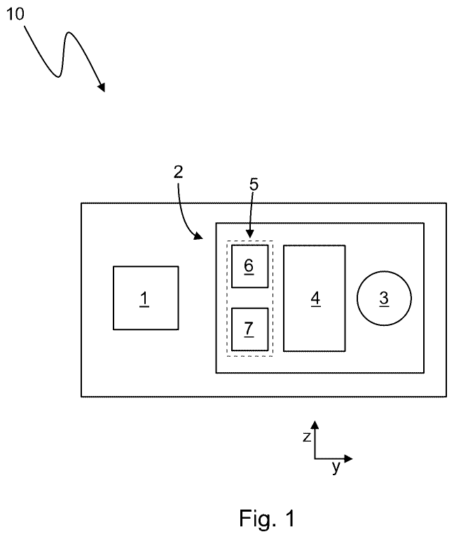

FIG. 1 a schematic representation of an electrical device,

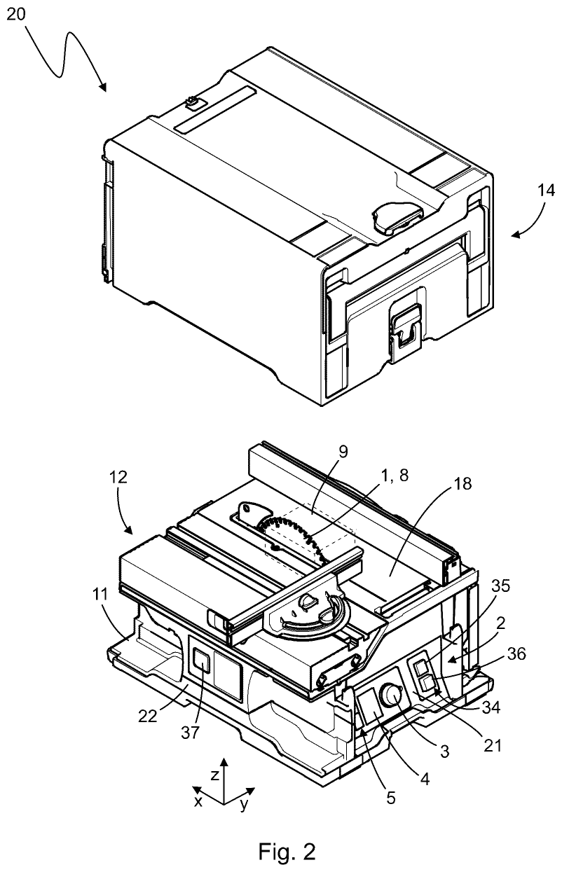

FIG. 2 a perspective representation of an electrical tool,

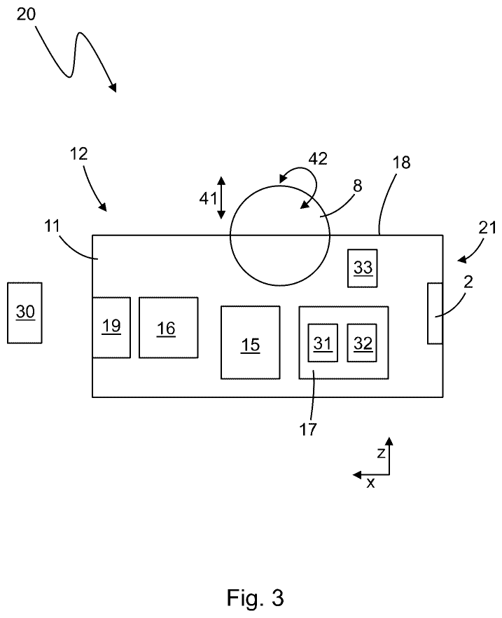

FIG. 3 a schematic representation of the electrical tool,

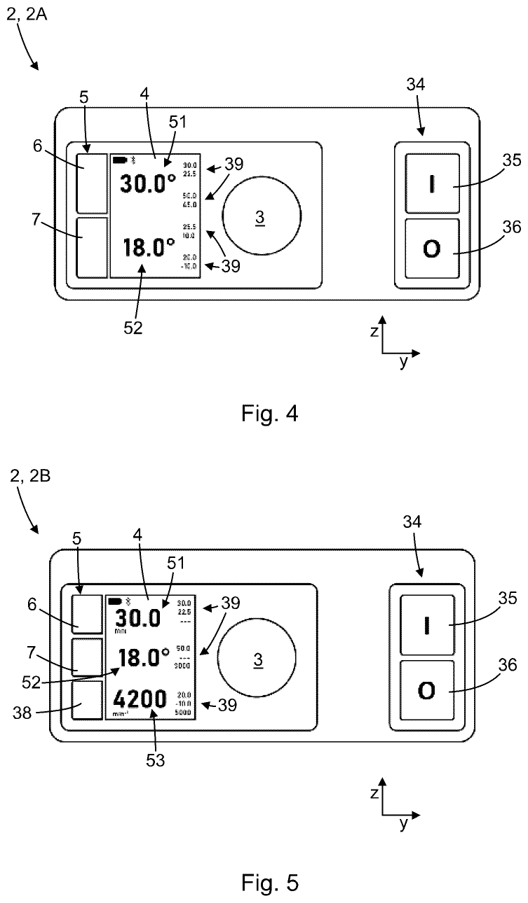

FIG. 4 a schematic representation of an operating device according to a first variant,

FIG. 5 a schematic representation of an operating device according to a second variant,

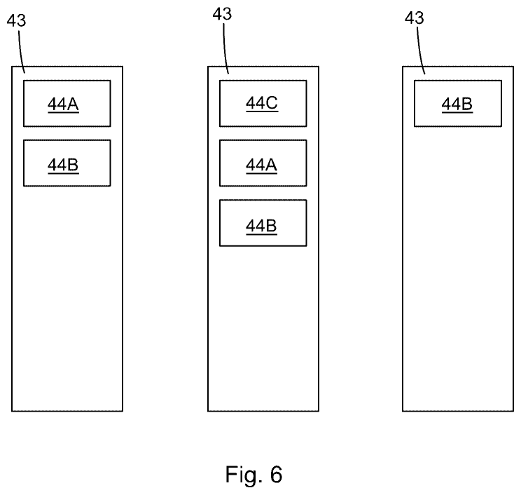

FIG. 6 schematic representations of a stack memory and

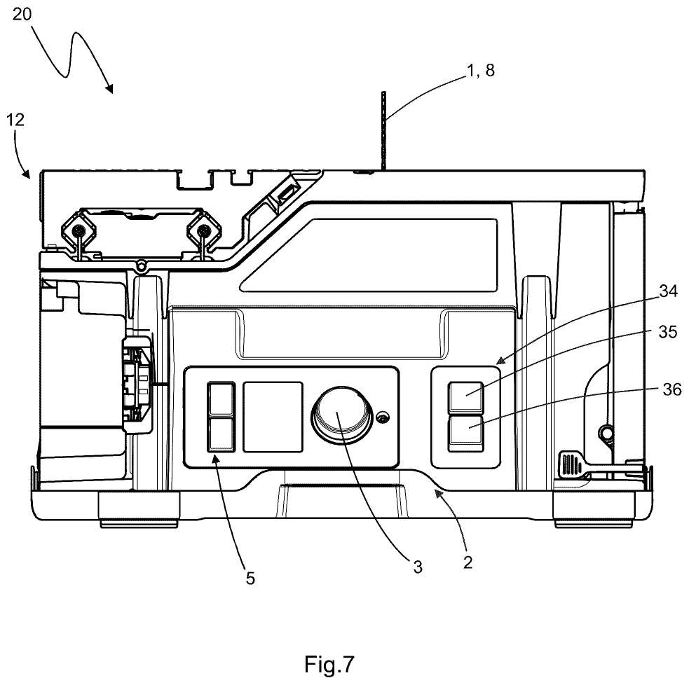

FIG. 7 a lateral view of the electrical tool.

With regard to the subsequent explanations, the directions x-direction, y-direction and z-direction which are drawn in the figures and which are aligned orthogonally to one another are referred to. The x-direction and the y-direction are horizontal directions and the z-direction is a vertical direction.

FIG. 1 show an electrical device 10 which in particular is designed as an electrical tool, for example as a saw device. The electrical device 10 comprises a functional unit 1 which by way of example is designed as a tool, in particular as a saw blade.

The electrical device 10 comprises an operating device 2 via which a parameter value of at least parameter which is related to the operation of the functional unit 1, in particular of the tool, can be inputted. The at least one parameter includes for example a cutting depth (in particular as the first parameter) and/or a cutting angle (in particular as the second parameter). The operating device 2 can also be denoted as a man-machine interface.

The operating device 2 comprises an adjustment element 3 which is preferably designed as a rotary push button. The adjustment element 3 serves for the input of the parameter value. Preferably, at least two parameter values of at least two different parameters which relate to the operation of the functional unit 1 can be inputted via the adjustment element 3.

The rotary push button in particular is designed as a rotary push wheel. The rotary push button is expediently designed in a circularly cylindrical manner. The rotary push button is rotatably mounted about a rotation axis. Expediently, the parameter value which is to be inputted with the rotary push button, in particular one or more digits of the parameter value can be increased by way of a rotation of the rotary push button about the rotation axis in a first rotation direction. Expediently, the parameter value which is to be inputted with the rotary push button, in particular one or more digits of the parameter value can be reduced by way of a rotation of the rotary push button about the rotation axis in a second rotation direction. The second rotation direction is opposite to the first rotation direction. The electrical device 10 expediently comprises an incremental encoder which converts a rotation movement of the rotary push button into an electrical signal which is provided for example as an electrical operating signal. The rotary push button can be pressed in particular in the axial direction of the rotation axis, in order to select one or more digits of the parameter value which are to be inputted.

The operating device 2 further comprises a display unit 4 for the display of the at least one parameter value. In particular, the display unit 4 is a graphic display, expediently a pixel display. The display unit 4 is for example an LCD or an OLED display. By way of example, the display unit 4 has a resolution of greater than 100×100 pixels, preferably 240×240 pixels.

Preferably, the operating device 2 further comprises a selection element arrangement 5 for the selection of a parameter as a current input parameter. That parameter whose parameter value can be currently inputted, in particular changed, with the adjustment element 3 is to be denoted as the current input parameter. In particular, a parameter of several possible parameters can be selected as the current input parameter via the selection element arrangement 5.

Preferably, the selection element arrangement 5 comprises selection elements 6, 7, 38. Expediently, each of the selection elements 6, 7, 38 is assigned to a respective parameter in order to select the respective parameter as the current input parameter. Preferably, each of the selection elements 6, 7, 38 is assigned to a respective display region of the display unit 4 which in particular serves for the display of the respectively assigned parameter.

By way of example, the selection element arrangement 5 comprises a first selection element 6 which in particular is designed as a first button and with which a first parameter, for example the cutting depth can be selected as the current input parameter. An actuation of the first selection element 6 selects the first parameter as the current input parameter, so that the parameter value of the first parameter (and in particular not the parameter value of a second parameter) can be inputted via the adjustment element 3.

Preferably, the selection element arrangement 5 comprises a second selection element 7 which in particular is designed as a second button and with which a second parameter, for example the cutting angle can be selected as the current input parameter. An actuation of the second selection element 7 selects the second parameter as the current input parameter, so that the parameter value of the second parameter (and in particular not the parameter value of the first parameter) can be inputted via the adjustment element 3.

By way of example, the second selection element 7 is arranged below the first selection element 6, in particular in a manner such that the first selection element 6 and the second selection element 7 are flush in the y-direction and/or distanced to one another in the z-direction. Expediently, the first selection element 6 and the second selection element 7 assume the same region in the y-direction. The selection element arrangement 5, in particular the first selection element 6 and/or the second selection element 7 are expediently arranged next to the display unit 4 in the (in particular negative) y-direction.

As already explained above, the electrical device 10 is preferably designed as a saw device. An exemplary embodiment of a corresponding saw device is explained in more detail hereinafter with reference to FIG. 2.

Firstly, exemplary other designs of the electrical device 10 are dealt with.

The electrical device 10 can be designed for example as a vacuum device and the functional unit 1 as a suction unit. The at least one parameter in this case is the suction power of the suction unit.

The electrical device 10 can further be designed as a router or jointer and the functional unit as a miller. For example, the at least one parameter in this case (e.g. as the first parameter) includes a rotation speed of the miller and/or (e.g. as the second parameter) a milling depth of the miller. In another example, the at least one parameter (e.g. as the first parameter) includes a first parameter of a milling program and/or (e.g. as the second parameter) a second parameter of a milling program.

The electrical device 10 can further be designed as a light beamer and the functional unit as a light means, for example as an LED unit. For example, the at least one parameter in this case (e.g. as the first parameter) includes a colour temperature of the light means and/or (e.g. as the second parameter) a brightness of the light means.

The electrical device 10 can further be designed as an audio output device, for example as a radio and the functional unit as a control device for the control of the audio output. For example, the at least one parameter in this case (e.g. as the first parameter) includes a volume of the audio output device and/or (e.g. as the second parameter) a station identifier which is assigned to a receivable station, and/or a playlist identifier which is assigned to a playable playlist.

FIG. 2 shows an electrical tool 20 which by way of example is designed as a saw device, in particular as a bench saw. The electrical tool 20 is an exemplary embodiment of the electrical device 10, so that the embodiments which relate to the electrical device 10 also apply to the electrical tool 20. In particular, that which has been stated with regard to the operating device 2 also applies to the operating device 2 of the electrical tool 20.

The electrical tool 10 is preferably designed as a semi-stationary machine. A semi-stationary machine is a machine which is placed in a stationary manner for machining a workpiece 9 and can be carried by an individual person.

The electrical tool 20 comprises a machining unit 12 which by way of example is designed as a saw unit. By way of example, the saw unit seen per se is a bench saw. Optionally, the electrical tool 20 further comprises a cover hood 14 which can be placed upon the machining unit 12 and preferably can be fastened to the machining unit 12. Preferably, the electrical tool 20 can be selectively brought into a working configuration and into a transport configuration. In the working configuration, the cover hood 14 is removed from the machining unit 12, so that expediently the workpiece 9 can be machined by the tool 8 of the machining unit 12. In the transport configuration, the cover hood 14 is placed upon the machining unit 12 and expediently covers the tool 8 and/or a workpiece rest surface 18 of the machining unit 12.

The electrical tool 20, in particular the machining unit 12 comprises the tool 8 which in particular is designed as a saw blade. The tool 8 is an example of the aforementioned functional unit 1. The tool 8 serves for machining a workpiece 9. The saw blade by way of example is aligned with its saw blade plane normally to the y-direction. The cutting direction of the saw blade by way of example runs parallel to the x-direction.

The electrical tool 20, in particular the machining unit 12 comprises a support structure 11 which by way of example has a parallelepiped basic shape. The electrical tool 20, in particular the machining unit 12 can be placed with the lower side (in particular aligned normally to the negative z-direction) of the support structure 11 on a base surface, in particular in order to assume a designated working position in which the workpiece 9 can be machined by the tool 8. The support structure 11 by way of example represents the outer housing of the machining unit 12.

The electrical tool 20 comprises the workpiece rest surface 18, on which the workpiece 9 can be placed, in order to machine the workpiece 9 with the tool 8. In the working position, the workpiece rest surface 18 is expediently aligned normally to the positive z-direction. By way of example, the workpiece rest surface 18 is formed by the upper side of the support structure 11. By way of example, the tool 8 projects out of an opening upwards out of the support structure 11, said opening being present in a workpiece rest surface 18, and/or can project into this support structure (in the negative z-direction).

The electrical tool 20 comprises the operating device 2 which in particular is designed as has already been discussed above. The operating device 2 is expediently arranged on the support structure 11, in particular on a first peripheral side 21 of the support structure 11. The operating device 2 in particular is arranged on the support structure 11 at the outside. The first peripheral side 21 extends upwards from the lower side of the support structure 11 to the upper side of the support structure 11. The first peripheral side 21 by way of example runs parallel to the y-direction. The first peripheral side 21 in particular is that side, from which the workpiece 9 can be pushed onto the tool 8 in a feed direction which runs parallel to the positive x-direction, in order to machine the workpiece 9 with the tool 8. The operating device 2 in particular is arranged on a section of the support structure or peripheral side, which is arranged in front of the tool 8 in the feed direction, in particular such that the tool 8 as is shown in FIG. 7 lies within the y-extension of the operating device 2 in the y-direction.

Expediently, in the transport configuration, the cover hood 14 covers the operating device 2, in particular in a complete manner, so that the operating device 2 cannot be operated in the transport configuration. In the working configuration, the cover hood 14 expediently does not cover the operating device 2.

FIG. 3 shows a schematic representation of the electrical tool 20, in particular of the machining unit 12.

The electrical tool 20 comprises a control unit 15 which in particular is arranged in the support structure 11. The control unit 15 comprises for example a microcontroller. The control unit 15 is communicatively connected to the operating device 2. Expediently, the control unit 2 receives at least one electrical operating signal from the operating device 2. The at least one electrical operating signal expediently represents an actuation of the operating device 2, in particular of the adjustment element 3 and/or of the selection element arrangement 5. The control unit 15 is expediently communicatively connected to the display unit 4. Expediently, the control unit 15 outputs at least one electrical display signal to the display unit 4, in particular whilst taking into account a user input which is carried out with the operating device 2, in particular whilst taking into account the at least one electrical operating signal.

Expediently, the electrical tool 20, in particular the machining unit 12 comprises a tool drive unit 16 which serves for bringing the tool 8 into a machining movement, by way of which the workpiece 9 can be machined. The tool drive unit 16 expediently comprises an electrical drive motor for the drive of the tool 8. The machining movement by way of example is a rotation movement of the saw blade, in particular about a rotation axis which runs parallel to the y-axis. The tool drive unit 16 is expediently arranged in the support structure 11. Expediently, the control unit 15 is designed to control the tool drive unit 16 with at least one drive signal, in particular on the basis of a user input which is carried out with the operating device 2, in order to set the drive of the tool 8.

Preferably, the electrical tool 20, in particular the machining unit 12 comprises a positioning device 17 which comprises at least one electric motor, for providing a displacement movement of the tool 8. The positioning device 17 is preferably arranged in the support structure 11.

The electrical tool 20 is designed to carry out the displacement movement for the purpose of repositioning the tool 8 and/or for the purpose of a calibration run of the tool 8.

The repositioning of the tool 8 is expediently effected relative to the workpiece rest surface 18 and serves for setting a first and/or a second parameter, in particular the cutting depth and/or the cutting angle.

The calibration run expediently serves for the detection of one or more reference positions, for example a maximal position, a minimal position and/or a zero position of the tool 8. For example, with the calibration run, the tool 8 is brought into one or more reference positions. Expediently, the electrical tool 20 has no absolute sensors for detecting the position of the tool 8 and/or is designed to incrementally determine the position of the tool 8, in particular whilst taking into account one or more reference positions which are detected with the calibration run.

By way of example the positioning device 17 comprises a first positioning electric motor 31 for setting a first parameter, in particular a height of the tool 8, in order to set the cutting depth. The tool 8 can expediently be positioned or moved in the z-direction, in particular relative to the workpiece rest surface 18, by way of the first positioning electric motor 31. In particular, the tool 8 can be brought into a first, in particular linear displacement movement 41 by way of the first positioning electric motor.

By way of example, the positioning device 17 comprises a second positioning electric motor 32 for setting a second parameter, for example an angle, of the tool 8, in particular in order to set the cutting angle. The tool 8 can expediently be pivoted about a pivot axis which in particular runs in the y-direction or can be displaced perpendicularly to the feed direction or x-direction in a plane which contains the z-direction, in particular relative to the workpiece rest surface 18, by way of the second positioning electric motor 32. In particular, the tool can be brought into a second displacement movement 42 by way of the second positioning electric motor 32. The second displacement movement is preferably a pivoting movement.

By way of example, the parameter value of the first parameter, in particular of the cutting depth can be changed by way of a selecting of the first parameter, in particular of the cutting depth, as the current input parameter and a subsequent rotation of the adjustment element 3. Preferably, the electrical tool 20 is designed, simultaneously with the changing of the parameter value which is effected by the rotating of the adjustment element 3, to position the tool 8 according to the parameter value amid the use of the first positioning electric motor 31.

By way of example, the parameter value of the second parameter, in particular of the cutting angle can be changed by way of a selecting of the second parameter, in particular the cutting angle, as the current input parameter and a subsequent rotating of the adjustment element 3. Preferably, the electrical tool 20 is designed, simultaneously with the changing of the parameter value which is effected by the rotating of the adjustment element 3, to position the tool 8 according to the changed parameter value amid the use of the second positioning electric motor 32.

A rotating of the adjustment element 3 expediently effects the changing of the parameter value of the current input parameter which is displayed on the display unit 4 and the simultaneous positioning of the tool 8 by the positioning device 17 according to the displayed (changed) parameter value.

The electric tool 20 is preferably designed to only carry out the displacement movement whilst an actuation of the operating device, in particular of the adjustment element is given, and as a response to the actuation of the operating device, in particular of the adjustment element no longer being given, to stop the displacement movement.

The electrical tool 20 is preferably designed to only carry out the displacement movement when the tool 8 is not situated in the machining movement.

In particular, the control unit 15 is designed to examine, in particular to continuously examine whether the adjustment element 3 is actuated, for example whether the adjustment element 3 is being rotated, in particular on the basis of the electrical operating signal, and to effect the displacement movement by way of the control of the positioning device 17 only for so long as the adjustment element 3 is actuated. The control unit 15 is preferably designed to carry out the continuous examining with a sampling rate of at least 20 Hertz, preferably at least 100 Hertz. The speed of a linear displacement movement is for example at least 5 millimetres/second. In a preferred embodiment variant, the linear displacement movement is 10 millimetres/second. The speed of a rotational displacement movement is for example at least 4 degrees/second. In a preferred embodiment, the speed of the rotational displacement movement is 6.5 degrees/second.

Preferably, the actuation of the operating device 2 is effected for the purpose of changing the parameter value, for example an increase or reduction of the parameter value. Such a change of the parameter value is an example of an input of the parameter value. The electrical tool 20 is designed to position the tool 8 according to the changed parameter value by way of the displacement movement. The electrical tool 20 is preferably designed to display the changing parameter value on the display unit 4 during the change of the parameter value and during the displacement movement.

In particular, by way of rotating the adjustment element 3, the user can increase or reduce the parameter value which is displayed on the display unit 4 and the electrical tool 20 simultaneously with this increase or reduction displaces the tool 8, and specifically in particular in a manner such that the parameter value which is displayed on the display unit 4 always describes the current position of the tool 8.

Thus expediently a user input (e.g. a rotation of the adjustment element 3) is necessary for the time duration of the displacement, for an automatic and/or electronically controlled displacing (e.g. the displacement movement) of the saw blade of the electrical tool 20.

In particular, a displacing of the saw blade is exclusively effected when an actuation of the adjustment element 3, preferably a rotation of the adjustment element 3 is effected. Optionally, the intensity of the input (for example the rotary speed of the adjustment element 3) has no influence on the displacement speed.

For example (in particular via the operating device 2) a desired tool setting, in particular one which is predefined or previously defined by the user, in particular a saw blade position, for example a parameter presetting 39, a parking position and/or an exchange position can be selected and/or a calibration run can be selected. The calibration run relates to the first parameter, in particular to the cutting angle, and/or to the second parameter, in particular to the cutting depth, and in particular is effected by way of moving to end positions. The parking position is a position of the tool, in particular of the saw blade, at which position the tool, in particular the saw blade is positioned deeply enough for the cover hood 14 to be able to be placed onto the machining unit 12 and fastened to this. The exchange position is a position of the tool, in particular of the saw blade, at which the tool, in particular the saw blade can be removed or exchanged, in particular exchanged by the user.

The electrical tool 20 is designed, for the purpose of moving to the desired tool position, in particular saw blade position and/or for carrying out the calibration run, to displace the tool, in particular the saw blade only when the rotary push button is rotated or pressed, and to only displace it only for so long as the rotary push button is rotated or pressed. Expediently, by way of this there is a reduced risk of a user accidentally contacting the saw blade during the displacing in the case of a small (portable, mobile or hand-held) saw device. According to an alternative design, instead of an input by the rotary push button, an input by another suitable user input element is necessary in order for the tool, in particular the saw blade to be displaced.

Expediently, the electrical tool 20 is designed, as a response to the user input (e.g. the pressing or rotating of the adjustment element 3) being ended before the desired saw blade position is reached and/or the calibration run is completed, to stop the displacement movement of the saw blade and to expediently output, in particular display an (in particular optical) signal, in particular an error message, in particular via the display unit 4 and/or to prevent a drive of the saw blade. The displacement movement can be expediently continued by way of a renewed user input (e.g. a pressing or rotating of the adjustment element 3).

As mentioned above, the displacement movement is effected in particular in the course of a calibration run. Preferably, the electrical tool 20 is designed to interrupt or abort the calibration run when the rotary push button is no longer rotated further before the completion of the calibration run of the saw blade.

Optionally, the electrical tool 20, in particular the machining unit 12 comprises a communication interface 19 for communication with a mobile device 30. The mobile device 30 is for example a mobile telephone or a tablet. The communication between the communication interface 19 and the mobile device 30 is preferably effected in a wireless manner, in particular via Bluetooth, WLAN, mobile radio and/or NFC.

Expediently, the electrical tool 20, in particular the machining unit 12 comprises a fan 33 which in particular serves for generating an airflow, in order to cool the electrical tool 20. The fan 33 is expediently coupled to the tool 8, in particular in a manner such that the fan 33 together with the tool 8 is driven by the tool drive unit 16. Preferably, the electrical tool 20 has a cooling mode in which the tool 8 is driven at a reduced speed in order via the fan 33 of the electrical tool 20 which is coupled to the tool 8 to effect a cooling of the electrical tool 20. The reduced speed in particular is reduced in comparison to a machining speed which is applied for machining the workpiece 9. The electrical tool 20 is designed, before the assumption of the cooling mode to output, in particular to display a warning signal which indicates the fact that the electrical tool 20 will assume the cooling mode, and/or during the cooling mode to output, in particular display a cooling mode signal which indicates that the electrical tool 20 is situated in the cooling mode. The warning signal and/or the cooling mode signal are expediently outputted, in particular displayed via the display unit 4, in particular as a respective message which is displayed on the display unit 4.

Hereinafter, the operating device 2 is dealt with in more detail. The subsequently explained operating device 2 in particular is the operating device 2 of the electrical device 10 and/or of the electrical tool 20, in particular the sawing device.

Preferably, the operating device 2 comprises a tool drive operating device 34, via which a drive of the tool 8 for bringing the tool 8 into the machining movement can be switched on or switched off. The drive of the tool 8 is effected by way of the tool drive unit 16. Expediently, the control unit 15 controls the tool drive unit 16 according to a user input which is carried out via the tool drive operating arrangement 34. The tool drive operating arrangement 34 comprises for example an on-button 35 for switching on the drive of the tool 8 and/or an off-button 36 for switching off the drive of the tool 8. The tool drive operating arrangement 34, in particular the on-button 35 and/or the off-button 36 by way of example are arranged on the first peripheral side 21. By way of example, the tool drive operating arrangement 34 is arranged next to the adjustment element 3, in particular at the right next to the adjustment element 3. By way of example, the off-button 36 is arranged below the on-button 35.

Preferably, the electric tool 20, in particular the machining unit 12 further comprises a main on/off switch 37 via which the electrical tool 20, in particular the operating device 2 can be switched on and/or switched off. Expediently, the electrical tool 20, in particular the control unit 15 can be brought into an off-state by way of actuating the main on/off switch 37, in which off state the drive of the tool 8 cannot be switched on via the tool drive operating arrangement 34. The main on/off switch 37 by way of example is arranged distanced to the tool drive operating arrangement 34. By way of example, the main on/off switch 37 is arranged on a second peripheral side 22 of the support structure 11. The second peripheral side 22 by way of example runs parallel to the x-direction.

Preferably, the display unit 4 is designed to display a first parameter value 51 of the first parameter and a second parameter value 52 of the second parameter. The first parameter value 51 in particular is the current value of the first parameter and the second parameter value 52 in particular is the current value of the second parameter. By way of example, the display unit 4 displays the parameters 51, 52 amongst one another. Expediently, the display unit 4 displays the parameter values as number elements, in particular via the representation of digits, in particular Arabic numerals.

The first selection element 6 is preferably arranged in a spatial association with the first parameter value 51 and/or the second selection unit 7 is arranged in a spatial association with the second parameter value 52. By way of example, the first selection element 6 assumes a first z-region and the first parameter value 51 are arranged in the first z-region. By way of example, the second selection element 7 assumes a second z-region which is different from the first z-region and the second parameter value 52 is arranged in the second z-region. Expediently, the first z-region, the first selection element 6 and/or the first parameter value 51 are arranged exclusively above an imagined straight line which runs in the y-direction and/or the second z-region, the second selection element 7 and/or the second parameter value 52 is arranged exclusively below an imagined straight line which runs in the y-direction.

FIG. 4 shows an operating device 2 according to a first variant. This operating device is also to be denoted as a first operating device 2A. The operating device 2 by way of example comprises at least two, in particular precisely two selection elements 6, 7 which expediently together have the same vertical extension as the display unit 4 and are vertically flush with the display unit 4.

By way of example, the electrical tool 20 is designed as a hand saw or as a bench saw and the first parameter is for example the cutting depth and/or the second parameter is the cutting angle.

The electrical tool 20 can further be designed as a mitre saw and the first parameter can be for example a mitre angle and/or the second parameter can be for example an inclination angle (in particular adjustable perpendicularly to the mitre angle).

FIG. 5 shows an operating device 2 according to a second variant. This operating device is also to be denoted as a second operating device 2B.

By way of example, the selection element arrangement 5 further comprises a third selection element 3 which in particular can be designed as a third button and with which a third parameter can be selected as the current input parameter. An actuation of the third selection element 38 selects the third parameter as the current input parameter, so that the parameter value of the third parameter can be inputted via the adjustment element 3.

The operating device 2 by way of example comprises at least three, in particular exactly three selection elements 6, 7, 38 which expediently commonly have the same vertical extension as the display unit 4 and are vertically flush with the display unit 4.

The display unit 4 is preferably designed to display a third parameter value 53 of the third parameter. The third parameter value 53 in particular is the current value of the third parameter.

Preferably, the third selection element 38 is arranged in a spatial association with the third parameter value 53. By way of example, the third selection element 38 assumes a third z-region which is different from the first z-region and the second z-region and the third parameter value 53 is arranged in the third z-region.

Expediently, the third z-region, the third selection element 38 and/or the third parameter value 53 are arranged exclusively below a second imagined straight line which runs in the y-direction, and/or the first z-region, the first selection element 6 and/or the first parameter value 51, and/or the second z-region, the second selection element 7 and/or the second parameter value 52 is/are arranged exclusively above the imagined second straight line which runs in the y-direction.

By way of example, the electric tool 20 is designed as a hand saw or as a bench saw and the first parameter is for example the cutting depth and/or the second parameter is the cutting angle and/or the third parameter is a speed of the saw blade.

The adjustment element 3 preferably comprises two input modes. The two input modes preferably include a pressed input mode and a non-pressed input mode. With regard to the pressed input mode, the adjustment element 3 is rotated whilst it is pressed by the user, in particular in the axial direction of the rotation axis, about which the adjustment element 3 is rotatable. Concerning the non-pressed input mode, the adjustment element 3 is rotated whilst it is not pressed, in particular not in the axial direction of its rotation axis. Preferably, one of the input modes, for example the non-pressed input mode serves for the input of at least one pre decimal point digit of the parameter value of the current input parameter and/or the other input mode, for example the pressed input mode serves for the input of at least one post decimal point digit of the parameter value of the current input parameter. Expediently, several, in particular all pre decimal point digits of the parameter value can be inputted with the one input mode and/or several, in particular all post decimal point digits of the parameter value can be inputted with the other input mode. Expediently, exclusively one or more pre decimal point digits (and in particular no post decimal point digit) can be inputted with the one input mode, in particular the non-pressed input mode and/or exclusively one or more post decimal point digits (and in particular no pre decimal point digit) can be inputted with the other input mode, in particular the pressed input mode. The control unit 15 is expediently designed to interpret a rotation of the adjustment element 3 in a non-pressed state of the adjustment element 3 as an input of one or more pre decimal point digits of the parameter value and/or to interpret a rotation of the adjustment element 3 in a pressed state as the input of one or more post decimal point digits of the parameter value.

According to an alternative embodiment, with regard to the pressed input mode, the adjustment element 3 is rotated whilst the selection element which is assigned to the parameter which is selected as the current input parameter is pressed.

Preferably, all parameter values which can be inputted can be inputted via the adjustment element 3—thus in particular via the rotary push button. Expediently, the electric tool 20 has no touchscreen, no letter block and no numeral block for the input of a parameter value.

Preferably, a main menu can be retrieved by way of pressing the adjustment element 3 twice. The main menu comprises a plurality of menu elements which are displayed on the display unit 4, in particular amongst one another. Expediently, a menu element can be selected from several possible menu elements by way of rotating the adjustment element 3 and the selection of the menu element can be confirmed by a pressing of the adjustment element 3.

The electrical tool 20 is preferably designed to simultaneously display several selectable parameter presettings 39 on the display unit 4. The parameter presetting 39 can also be denoted as parameter favourites or as parameter presets. Preferably, each parameter presetting 39 can comprise respective parameter values of the parameters, said parameters being able to be selected by the selection elements, in particular of all parameters which can be selected by the selection elements. Preferably, each parameter presetting 39 can comprise two parameter values of two different parameters. The parameter values of a parameter presetting 39 are also to be denoted as presetting parameter values. Expediently, the parameter presettings 39 are displayed amongst one another on the display unit 4, in particular laterally next to the first parameter value 51 and/or the second parameter value 52 and/or (inasmuch as is present) the third parameter value 53. Expediently, the parameter presettings 39 are displayed simultaneously with the parameter values 51, 52 and/or 53. In particular, the parameter presettings 39 are displayed on the display unit 4 as a list. The list expediently extends over the entire height of the display unit 4. By way of example, simultaneously at least two, at least three or at least four parameter presettings 39 are displayed on the display unit 4.

Alternatively, one can envisage each parameter presetting 39 only comprising one parameter value of a single parameter. Expediently, in this case each parameter presetting 39 is arranged in the z-region of that selection element which is assigned to the parameter to which the respective parameter presetting 39 relates.

Preferably, not all present parameter presettings 39 are displayed simultaneously and/or one can scroll through all present parameter presettings 39 by way of rotating the adjustment element 3.

Optionally, the electric tool 20 can be designed, as a response to the tool, in particular the saw blade, not being located in a parking position so that the cover hood 14 cannot be correctly placed onto the machining unit 12 and/or fastened to this on account of the current position of the tool, in particular of the saw blade, to display a parking position symbol on the display unit 4, via whose selection the tool, in particular the saw blade can be brought into the parking position. The parking position symbol can be displayed for example in the list of presettings 39. Optionally, the electrical tool 20 can be designed, as a response to the tool, in particular the saw blade being located in the parking position, so that the cover hood 14 can be correctly placed onto the machining unit 12 and/or fastened to this, to not display the parking position symbol.

As is shown in FIG. 4 by way of example, each parameter presetting 39 can comprise a first presetting parameter value for the first parameter, for example the cutting depth, and/or a second presetting parameter value for the second parameter, for example the cutting angle. Each parameter presetting 39 by way of example is displayed on the display unit 4 by way of the presetting parameter values which each belong to the parameter presetting 39 being displayed by way of example amongst one another, in particular as digits.

As is shown by way of example in FIG. 5, each parameter presetting 39 can optionally comprise up to three presetting parameter values which are expediently displayed amongst one another.

Preferably, currently set parameter values can be stored as a parameter presetting 39 by way of simultaneous pressing of at least two selection elements—for example the first selection element 6 and the second selection element 7. The currently set parameter values in particular are the currently displayed first parameter value 51 and/or the currently displayed second parameter value 52 and/or (inasmuch as is present) the currently displayed third parameter value 53.

Preferably, one of the currently set parameter values can be deselected by way of pressing the assigned selection element in order to effect this currently set parameter value not being co-stored on storing a parameter presetting 39. Optionally, the deselection of the parameter value can be undone by way of pressing the assigned selection element once again.

Optionally, the memory position of a parameter presetting 39 which is to be newly stored, in particular within the list, can be set via the adjustment element 3, in particular only via the adjustment element 3, in particular by way of rotating the adjustment element in order to select the memory position, and subsequent pressing of the adjustment element 3 in order to confirm the selection.

Optionally, the electric tool 20 is designed to receive at least one of the parameter presettings 39 from the mobile device 30 via the communication interface 19. Preferably, the electrical tool 20 comprises personalised parameter presettings which have been received for example from the mobile device 30 and non-personalised parameter presettings which for example have not been received by the mobile device 30. Expediently, the electrical tool 20 is designed to deal with the personalised parameter presettings differently than the non-personalised parameter presettings. For example, the electrical tool 20 is designed, during a coupling to the mobile device 30, to display the personalised parameter presettings and/or not to display the non-personalised parameter presettings. For example, the electrical tool 20 is designed, after a completion of the coupling to the mobile device 30, to no longer display the personalised parameter presettings and/or to display the non-personalised parameter presettings.

Preferably, one can scroll through the parameter presettings 39 via a rotation of the adjustment element 3, in order to select a parameter presetting 39, and the selected parameter presetting 39 can be activated via a pressing of the adjustment element 3. The presetting parameter values of the selected parameter presetting 39 is set as the first parameter value 51, as the second parameter value 52 and (inasmuch as is present) as the third parameter value 53 by way of activating the parameter presetting 39.

Preferably, the electrical tool 20, in particular the control unit 15 is designed to implement a rotating of the adjustment element 3 as scrolling through the parameter presettings 39 when no parameter is selected as the current input parameter.

Optionally, the electric tool 20 comprises a passive operating mode in which the tool 8 cannot be brought into the machining movement for machining the workpiece 9. For example, the control unit 15 blocks the drive of the tool 8 (in particular provided via the tool drive unit 16) in the passive operating mode. In the passive operating mode, the electrical tool 20 via the display unit 4 displays operating instruction information, in order to expediently inform a user about the designated handling of the electrical tool 20. The electrical tool 20 further comprises an active operating mode, in which the tool 8 can be brought into the machining movement. For example, the control unit 15 in the active operating mode enables the drive of the tool 8 via the tool drive unit 16. Optionally, the control unit 15 on starting operation of the electrical tool 20—in particular on switching on the electrical tool 20 for the first time—automatically effects the electrical tool 20 firstly assuming the passive operating mode and expediently changing into the active operating mode only after one or more actuations of the adjustment element 3, by way of which one or more displayed user instruction information is confirmed.

Preferably, the electric tool 20 is designed to display the passive operating mode and/or the active operating mode by way of a respective display operating mode of the display unit 4, in particular by a respective background brightness. For example, the control unit 15 in the passive operating mode sets a darker background brightness of the display unit 4 than in the active operating mode. What is meant by background brightness is for example the brightness of the colour tone of the background colour. For example, the control unit 15 sets a darker colour tone of the background colour of the display unit 4 in the passive operating mode than in the active operating mode.

Preferably, the electrical tool 20 comprises a display stack memory 43. FIG. 6 schematically shows representations of an exemplary display stack memory 43 in three different states. The display stack memory 43 is implemented for example per software, in particular in the control unit 15.

Message objects 44A, 44B, 44C which are assigned to respective messages, in particular error messages which are to be displayed on the display unit 4, are kept in the display stack memory 43. In the first state which is shown on the left, a first message object 44A and a second message object 44B are kept in the display stack memory 43. In the second state which is shown in the middle, a third message object 44C has been added. In the third state which is shown on the right, it is only the second message object which is still present in the display stack memory.

The electrical tool 20 is designed to display that message on the display unit 4 which is assigned to the message object which is located in the display stack memory 43 at the first position, in particular to display it in a complete manner. This message is also to be denoted as a current display message. Expediently, the electrical tool 20 is designed not to display the other messages—thus those messages which are assigned to the message objects which are not located at the first position—and/or to only partly display them, for example to display them partially covered by the current display message. In the state which is shown on the left, the electrical tool 20 displays the message which is assigned to the first message object 44A (located at the first position) in a complete manner on the display unit 4 and does not display the message which is assigned to the second message object or only in a partial manner. In the state which is shown in the middle, the electrical tool 20 completely displays the message which is assigned to the third message object 44C (located at the first position), on the display unit 4 and does not display the messages which are assigned to the other message objects 44A, 44B or only partly. In the state which is shown on the right, the electrical tool 20 completely displays the message which is assigned to the second message object 44B (located at the first position), on the display unit 4.

Expediently, the electrical tool 20 is designed, as a response to a confirmation input which is carried out with the operating device 2 (in particular by the user), to remove the message object which is located at the first position from the display stack memory 43, so that the message objects which are behind move forward by one position. The confirmation input is effected for example by the adjustment element 3, in particular by a pressing of the adjustment element 3. For example, an confirmation input is firstly effected for the third message object 44C which is located at the first position, in the transition from the state which is shown in FIG. 6 in the middle to the state which is shown on the right, by which means the third message object 44C is removed from the display stack memory 43 and the first message object 44A and the second message object move up by one position, so that the first message object 44A is at the first position. A confirmation input for the first message object 44A which is now located at the first position is then effected, by which means the first message object 44A is removed from the display stack memory 43 and the second message object 44B moves up by one position, so that the second message object 44B is at the first position.

Expediently, the electrical tool 20 is designed, as a response to a predefined event which activates a further message, to set a message object which is assigned to the further message at the first position in the stack memory 43 and to move back by one position the message objects which were previously present in the memory stack 43. Concerning the predefined event, it is the case for example of an error event which is recognised by the control unit 15. For example, a predefined event occurs in the transition from the state which is shown in FIG. 6 on the left to the state which is shown in the middle and this event activates a message which is assigned to the third message object 44C, so that the third message object 44C is put at the first position in the stack memory 43 and the message objects 44A, 44B which were previously present in the stack memory each move to the rear by one position.

In particular, the control unit 15 is designed to continuously display the newest message on the display unit 4 and with the newest message to cover one or more previously displayed messages. Expediently, the control unit 15 is designed, as a response to the confirmation input which is carried out with the operating device 2, to remove the newest message and to display that message which was previously covered by the newest message which is then removed.

The electrical tool 20 can be expediently operated with a method which comprises the step: input of the parameter value via the adjustment element 3.

Preferably, the first parameter is selected as the current input parameter via a confirmation of the first selection element 6. The parameter value of the current input parameter—thus of the first parameter—is then changed and by way of this is inputted, expediently by way of rotating the adjustment element 3. By way of example, firstly the adjustment element 3 is inputted in the non-pressed input mode, in order to change and by way of this input one or more pre decimal point digits of the parameter value. During this, the parameter value is displayed on the display unit 4. Preferably, during the rotation of the adjustment element 3, the electric tool 8 positions the tool 8 according to the changed (and currently displayed) parameter value. As soon as the rotating of the adjustment element 3 is completed, the electrical tool 20 stops a displacement movement of the tool 8 which is carried out for the purpose of the positioning of the tool 8. By way of example, the adjustment element 3 is then rotated in the pressed input mode, in order to change and by way of this input one or more post decimal point digits of the parameter value. During this, the parameter value is displayed on the display unit 4. Preferably, during the rotating of the adjustment element 3, the electrical tool 20 positions the tool 8 according to the changed (and currently displayed) parameter value. As soon as the rotating of the adjustment element 3 is completed, the electrical tool 20 stops a displacement movement of the tool 8 which is carried out for the purpose the positioning of the tool 8.

Expediently, the second parameter is selected as the current input parameter via an actuation of the second selection element 7. The input of the parameter value is then expediently effected in the same manner as has been explained beforehand in the context of the parameter value of the first parameter.

Optionally, the electrical tool 20 can be operated by a method which comprises the steps:
providing message objects 44A, 44B, 44C which are assigned to messages, in particular error messages, which are to be respectively displayed on the display unit 4,
displaying that message which is assigned to the message object which is located at the first position in the display stack memory 43,
as a response to a confirmation input which is carried out by the operating device 2, removing the message object which is located at the first position from the stack memory 43, so that the message objects which are behind move up by one position, and/or
as a response to a predefined event which activates a further message, setting a message object which is assigned to the further message at the first position in the stack memory 43 and setting back by one position the message objects which were previously present in the stack memory.

1-20. (canceled)

21. An electrical tool comprising a tool for machining a workpiece, wherein the electrical tool comprises an operating device via which a parameter value of at least one parameter which relates to the operation of the tool can be inputted, wherein the operating device comprises an adjustment element which is designed as a rotary push button, for the input of the parameter value, as well as a display unit for the display of the at least one parameter value.

22. The electrical tool according to claim 21, further comprising a selection element arrangement for the selection of a parameter as a current input parameter, whose parameter value can be currently inputted by the adjustment element.

23. The electrical tool according to claim 22, wherein the selection element arrangement comprises a first selection element with which a first parameter can be selected as the current input parameter and wherein the selection element arrangement comprises a second selection element with which a second parameter can be selected as the current input parameter.

24. The electrical tool according to claim 23, wherein the display unit is designed to display a first parameter value of the first parameter and a second parameter value of the second parameter, wherein the first selection element is arranged in a spatial assignment to the first parameter value and the second selection element is arranged in a spatial assignment to the second parameter value.

25. The electrical tool according to claim 21, wherein the adjustment element comprises two input modes, namely a pressed input mode and a non-pressed input mode, and one of the input modes serves for the input of at least one pre decimal point digit of the parameter value and the other input mode for the input of at least one post decimal point digit of the parameter value.

26. The electrical tool according to claim 21, wherein all parameter values which can be inputted into the electrical tool can be inputted via the adjustment element.

27. The electrical tool according to claim 21, wherein a main menu can be opened via twice pressing the adjustment element.

28. The electrical tool according to claim 21, wherein the electrical tool is designed to simultaneously display several selectable parameter presettings on the display unit, wherein each parameter presetting comprises at least two presetting parameter values of two different parameters.

29. The electrical tool according to claim 28, further comprising a selection element arrangement for the selection of a parameter as a current input parameter, whose parameter value can be currently inputted by the adjustment element, wherein the selection element arrangement comprises a first selection element with which a first parameter can be selected as the current input parameter and wherein the selection element arrangement comprises a second selection element with which a second parameter can be selected as the current input parameter, wherein currently set parameter values can be stored as a parameter presetting by way of simultaneous pressing of the two selection elements.

30. The electrical tool according to claim 28, further comprising a communication interface for the communication with a mobile device, wherein the electrical tool is designed to receive at least one of the parameter presettings from the mobile device via the communication interface.

31. The electrical tool according to claim 28, wherein the parameter presettings can be scrolled through via a rotating of the adjustment element, in order to select a parameter presetting, and the selected parameter presetting can be activated via a pressing of the adjustment element.

32. The electrical tool according to claim 21, further comprising a positioning device which comprises at least one electric motor, for providing a displacement movement of the tool, wherein the electrical tool is designed to carry out the displacement movement for the purpose of a repositioning of the tool and/or for the purpose of a calibration run of the tool, and wherein the electrical tool is designed to only carry out the displacement movement whilst an actuation of the operating device is given, and as a response to the actuation of the operating device no longer being given, to stop the displacement movement.

33. The electrical tool according to claim 32, wherein the actuation of the operating device is effected for the purpose of a change of the parameter value and the electrical tool is designed to position the tool according to the changed parameter value by way of the displacement movement.

34. The electrical tool according to claim 33, wherein the electrical tool is designed to display, during the change of the parameter value and the displacement movement, the changing parameter value on the display unit.

35. The electric tool according to claim 21, wherein the electrical tool comprises a passive operating mode in which the tool cannot be brought into a machining movement for machining the workpiece and in which the electrical tool via the display unit displays operating instruction information, in order to inform a user on the designated use of the electrical tool and wherein the electrical tool further comprises an active operating mode, in which the tool can be brought into the machining movement.

36. The electrical tool according to claim 35, wherein the electrical tool is designed to display the passive operating mode and/or the active operating mode by way of a respective display operating mode of the display unit.

37. The electrical tool according to claim 21, wherein the operating device comprises a tool drive operating arrangement, via which a drive of the tool can be switched on and/or be switched off for bringing the tool into a machining movement, wherein the electrical tool further comprises a main on/off switch, via which the electrical tool can be switched on and/or switched off.

38. The electrical tool according to claim 21, wherein the electrical tool comprises a display stack memory in which message objects are kept, said message objects being assigned to respective messages which are to be displayed on the display unit, wherein the electrical tool is designed to display that message which is assigned to the message object which is located at the first position in the display stack memory, and as a response to a confirmation input which is carried out with the operating device, to remove the message object which is located at the first position from the stack memory, so that the message objects which are behind each move up by one position, and/or as a response to a predefined event which activates a further message, to place a message object which is assigned to the further message at the first position in the stack memory and to move back by one position the message objects which were previously present in the stack memory.

39. The electrical tool according to claim 21, wherein the electrical tool comprises a cooling mode, in which the tool is driven at a reduced speed, in order to effect, via a fan of the electrical tool which is coupled to the tool, a cooling of the electrical tool, wherein the electrical tool is designed, before the assumption of the cooling mode, to output a warning signal which displays that the electrical tool will assume the cooling mode and/or during the cooling mode to output a cooling mode signal which displays that the electrical tool is situated in the cooling mode.

40. A method for the operation of an electrical tool according to claim 21, comprising the step:
inputting the parameter value via the adjustment element.

41. The electric tool according to claim 23, wherein the electrical saw is a saw device, the tool is a saw, the first parameter is a cutting depth and the second parameter is a cutting angle.
